(19) United States
(12) Patent Application Publication
(10) Pub. No.: US 2004/0203383 A1
(43) Pub. Date: Oct. 14, 2004

(54) System for providing data to multiple devices and method thereof

(76) Inventors: James Robert Kelton, Austin, TX (US); James Ward Girardeau JR., Austin, TX (US); Michael R. May, Austin, TX (US); Michael D. Cave, Austin, TX (US); Mathew A. Rybicki, Austin, TX (US); James Doyle, Toronto (CA); Anselmo Pilla, Newmarket (CA); Shawn Saleem, Toronto (CA); Paul M. Astrachan, Austin, TX (US)

Correspondence Address: GARLICK HARRISON & MARKISON LLP, P.O. BOX 160727, AUSTIN, TX, 78716-0727, US

(21) Appl. No.: 10/376,853

(22) Filed: Feb. 28, 2003

Related U.S. Application Data
(60) Provisional application No. 60/437,173, filed on Dec. 31, 2002.

(51) Int. Cl. H04Q 7/20

(52) U.S. Cl. 455/41.2; 455/519

(57) ABSTRACT

A system and method for communicating with a plurality of devices are disclosed. One embodiment of the method includes transmitting a first plurality of sets of data on a plurality of data channels to a plurality of devices, wherein each of the first plurality of sets of data has a corresponding channel from the plurality of data channels and is transmitted to a corresponding device of the plurality of devices, and receiving a second plurality of sets of data on at least one of the plurality of data channels, wherein the second plurality of sets of data is sent by the plurality of devices, and wherein each of the second plurality of sets of data has a corresponding device of the plurality of devices. The second plurality of sets of data can include an acknowledgement from its corresponding device of the reception of at least one of the first plurality of data sets. Further, different channels of the plurality of data channels can include separate bands of frequencies.

This patent application is claiming priority under 35 USC § 119(e) and §120 to:

co-pending patent application entitled SYSTEM FOR PROVIDING DATA TO MULTIPLE DEVICES AND METHOD THEREOF, having a Ser. No. of 09/990,896, and a filing date of Nov. 16, 2001; and

provisional patent application having the same title as the present patent application, having a serial No. of 60/437,173, and a filing date of Dec. 31, 2002.

### TECHNICAL FIELD OF THE INVENTION

The present invention relates generally to providing data and more particularly to providing data to multiple clients.

### BACKGROUND OF THE INVENTION

The market for wireless communication has achieved tremendous growth. Wireless communication offers the potential of reaching virtually every location on the face of the earth. The use of pagers and cellular phones is now commonplace. Wireless communication is also used in personal and business computing. Wireless communication offers networked devices flexibility unavailable using a physically connected network. Untethered from conventional network patient records, real-time vital signs and other reference data at a patient's bedside without relying on paper handling or reams of paper charts. Factory floor workers can access part and process specifications without wired network connections, which may be impractical on the factory floor. Workers can inventory and verify warehouse content using wireless scanners linked to a main database. Multimedia data may be served to various home entertainment devices within a home without a need to install cabling between all of the various home entertainment devices.

Standards for conducting wireless communications between networked devices, such as in a local area network (LAN), are known. The Institute for Electrical and Electronics Engineers (IEEE) offers a standard for multiple carrier communications over wireless LAN systems, IEEE 802.11. IEEE 802.11 includes standard proposals for wireless LAN architectures. Supported architectures include an ad-hoc LAN architecture in which every communicating device on the network can communicate directly with every other node. In the ad-hoc LAN architecture, there are no fixed nodes on the network and devices may be brought together to form the network “on the fly”. One method of maintaining an ad-hoc network includes defining one device as being a network master with other devices representing network slaves. Another supported architecture is the infrastructure in which the network includes fixed network access points. Mobile devices access the network through the network access points, which may be connected to a wired local network.

IEEE 802.11 also imposes several specifications on parameters of both physical (PHY) and medium access control (“MAC”) layers of the network. The PHY layer handles the transmission of data between network nodes or devices and is limited by IEEE 802.11a to orthogonal frequency division multiplexing (“OFDM”). IEEE 802.11a utilizes the bandwidth allocated in the five GHz Unlicensed National Information Infrastructure (“UNII”) band. Using OFDM, lower-speed subcarriers are combined to create a single high-speed channel. IEEE 802.11 a defines 12 non-overlapping 20 MHz channels. Each of the channels is divided into 64 subcarriers, each approximately 312.5 KHz wide. The subcarriers are transmitted in parallel. Receiving devices process individual signals of the subcarriers, each individual signal representing a fraction of the total data.

Other standards also exist within IEEE 802.11. For example, IEEE 802.11b limits the PHY layer to either direct sequence spread spectrum (DSSS), frequency-hopping spread spectrum, or infrared (IR) pulse position modulation. Spread spectrum is a method of transmitting data through radio frequency (RF) communications. Spread spectrum is a means of RF transmission in which the data sequence occupies a bandwidth in excess of the minimum bandwidth necessary to send it. Spectrum spreading is accomplished before transmission using a code that is independent of the data sequence. The same code is used in the receiver (operating in synchronism with a transmitter) to despread the received signal so that an original data sequence may be recovered. Direct sequence spread spectrum modulation uses the original data sequence to modulate a wide-band code. The wide-band code transforms the narrow band, original data sequence into a noise-like wide-band signal. The wide-band signal then undergoes a form of phase-shift keying (“PSK”) modulation. Frequency-hopping spread spectrum widens the spectrum associated with a data-modulated carrier by changing the carrier frequency in a pseudo-random manner.

Data channels link devices. A data channel is a frequency band used for transmitting data. Multiple carriers within a data channel may be utilized for transmitting data. Carriers are specific frequencies used to provide a set of data. Each carrier is assigned a constellation. The constellation is a map including various points identifying particular symbols used for transmitting a particular set of bits. The number of bits assigned to a point indicates a number of bits transferred per symbol received. Different carriers may be assigned unique constellations.

IEEE 802.11a, IEEE 802.11b and IEEE 802.11g specify a specific MAC layer technology, carrier sense multiple access with collision avoidance (CSMA-CA). CSMA is a protocol used to avoid signals colliding and canceling each other out. When a device or node on the network receives data to be transmitted, the node first “listens” to ensure no other node is transmitting. If the communications channel is clear, the node transmits the data. Otherwise, the node chooses a random “back-off factor” that determines an amount of time the node must wait until it is allowed to access the communications channel. The node decrements a “back-off” counter during periods in which the communications channel is clear. Once the “back-off” counter reaches zero, the node is allowed to attempt a channel access.

While communications standards, such as IEEE 802.11a, allow a single transmitting device to provide data to multiple receiving devices, the quality of data received by some receiving devices may be degraded. One quality of a signal is commonly measured using the signal-to-noise ratio (“SNR”) of the signal at the receiving device. Another metric to measure the quality of received data is the bit error rate (“BER”). As the signal-to-noise ratio becomes too low for a particular data signal, the BER associated with a receiving device may be too high for the receiving device. The distance a signal must travel can affect its signal-to-noise ratio. For example, a receiving device may be located too far from a data transmitter.

A signal-to-noise ratio can be dependent on the power of the transmitted signal, assuming a sufficient signal-to-noise ratio may be output by the data transmitter. Thus, the transmission power associated with a data signal transmitted to a particular receiving device may be too low. Interference from other data transmitters or other radio frequency (“RF”) radiators may also degrade a signal. A receiving device with a low signal-to-noise ratio may request data at a lower bit rate from the data transmitter. More transmission time on the data channel can become reserved for transmitting data to the receiving device with the low signal-to-noise ratio. Accordingly, other devices may not be able to access the data channel as needed. Furthermore, a transmission data rate for a particular data channel may be inadequate for a high-bandwidth receiving device. The data channel can be configured to transmit data at a maximum data rate, such as according to the IEEE 802.11 standard, or to transmit data at a maximum data rate acceptable by a particular receiving device. A high-bandwidth receiving device may require a large amount of data; however, due to limitations configured into the data channel, the required amount of data may not be accessible to the high-bandwidth receiving device using the data channel.

From the above discussion, it is apparent that an improved method of transmitting data to multiple devices is needed.

### BRIEF DESCRIPTION OF THE DRAWINGS

Specific embodiments of the present invention are shown and described in the drawings presented herein. Various objects, advantages, features and characteristics of the present invention, as well as methods, operations and functions of related elements of structure, and the combination of parts and economies of manufacture, will become apparent upon consideration of the following description and claims with reference to the accompanying drawings, all of which form a part of this specification, and wherein:

FIG. 1 is a block diagram illustrating a system for communicating with a plurality of receiving devices, according to one embodiment of the present invention;

FIG. 2 is a simplified block diagram illustrating a multi-transmitter and multi-channel embodiment of a system and method for transmitting data to a plurality of devices in accordance with the present invention;

FIG. 3 is a flow diagram describing a method of communicating with a plurality of devices, according to one embodiment of the present invention;

FIG. 4 is a flow diagram illustrating a method of identifying transmission problems associated with transmission time discrepancies, according to one embodiment of the present invention;

FIG. 5 is a flow diagram illustrating a method of handling transmission time ,discrepancies in a channel with a lower transmission time, according to one embodiment of the present invention;

FIG. 6 is a flow diagram illustrating a method of handling transmission time discrepancies in a channel with a greater transmission time, according to one embodiment of the present invention;

FIG. 7 is a block diagram illustrating alterations between numbers of bits transferred per unit time to correct for differences in transmission time, according to one embodiment of the present invention;

FIG. 8 is a block diagram illustrating a data field to correct for differences in transmission time, according to one embodiment of the present invention;

FIG. 9 is a block diagram illustrating a data packet padded with null data to correct for differences in transmission time, according to one embodiment of the present invention; and

FIG. 10 is a flowchart illustrating an embodiment of a method for adjusting transmission power on a data channel in accordance with the teachings of the present invention.

### DETAILED DESCRIPTION OF THE INVENTION

At least one embodiment of the present invention provides for a method of communicating with a plurality of devices. The method includes transmitting a first plurality of sets of data on a plurality of data channels to a plurality of devices, wherein each of the first plurality of sets of data has a corresponding channel from the plurality of data channels and is transmitted to a corresponding device of the plurality of devices and receiving a second plurality of sets of data on at least one of the plurality of data channels, wherein the second plurality of sets of data is sent by the plurality of devices, and wherein each of the second plurality of sets of data has a corresponding device of the plurality of devices. The second plurality of sets of data can include an acknowledgement from its corresponding device of the reception of at least one of the first plurality of data sets. Further, different channels of the plurality of data channels include separate bands of frequencies.

The plurality of devices is associated with a communication standard, such as the IEEE 802.11 communication standard. At least one of the plurality of clients can simultaneously receive multiple sets of data of the first plurality of sets of data not only along a corresponding data channel, but also along at least two of the plurality of data channels. In such a case, the multiple sets of data together comprise a composite data set (i.e., each of the multiple sets of data is a fraction of an intended total transmission). The multiple sets of data are combined at the at least one of the plurality of devices to form the composite data set. In a similar manner, each of the plurality of data channels can provide data sets to multiple devices of the plurality of devices (e.g., at least one of the plurality of data channels can do so at one time).

Another embodiment of the present invention provides a method for adjusting transmission power on a data channel transmitting to one or more devices. The method includes determining an available channel capacity of the data channel; determining an average data rate for each of the one or more devices; obtaining a quality of service (“QOS”) feedback signal from each of the one or more devices; determining an allocated channel capacity for each of the one or more devices based on one or more of the device average rate, the device QOS feedback signal, and the available channel capacity; and setting the transmission power to the one or more devices based on the allocated channel capacity. The method can further include the step of configuring the data channel to further receive data associated with the one or more devices. Determining the allocated channel capacity can further be based on an amount of data to be transmitted to each of the one or more devices and/or on a received signal quality, wherein the one or more devices provide the received signal quality as part of the QOS feedback signal. The signal quality can be based on a signal-to-noise ratio and/or on a bit error rate. Additional embodiments of the present invention can comprise a source device to communicate with a plurality of devices to carry out at least some of the functions disclosed above.

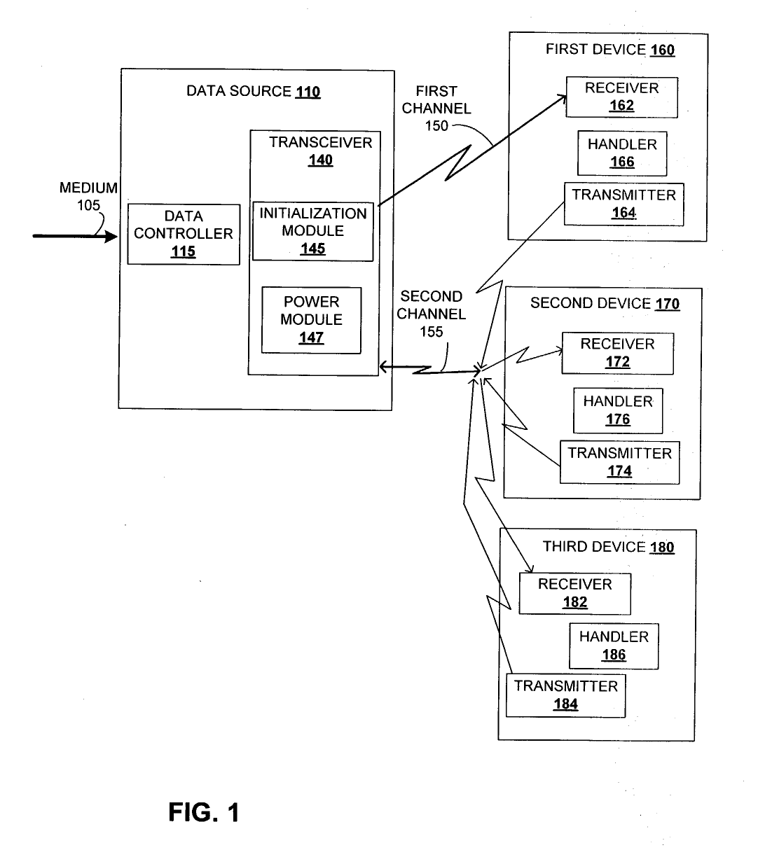

Referring now to FIG. 1, a block diagram illustrating a system for communicating with a plurality of devices is shown, according to one embodiment of the present invention. A transmitting device, data source 110, provides data to devices on a wireless LAN including devices 160, 170 and 180. Data source 110 provides portions of data received through a medium 105 to a first device 160 using first channel 150 and to a second device 170 and a third device 180 using a second channel 155. Devices 160, 170 and 180 return data using the second channel 155. Although FIG. 1 shows a two-channel data source 110, data source 110 can comprise a plurality of data channels as allowed by the particular communications standard in use. The plurality of data channels can be associated with a plurality of transceivers within data source 110. Further, the plurality of devices 160, 170 and 180 can return data along any one or multiple data channels of the plurality of data channels.

In one embodiment, data source 110 is a master device of a LAN system and is capable of providing data to other devices over a wireless communications link using a communications standard, such as IEEE 802.11. Data source 110 can use various frequency bands, such as channels 150 and 155, as communication links to devices 160, 170 and 180. Channels 150 and 155, as well as any other channels that data source 110 may use, can be adjacent data channels or alternate adjacent data channels as supported by the communications standard in use. Data source 110 receives data from an external source (not shown), such as through medium 105. The external source can include a satellite television provider, a digital television provider, an analog television provider, a digital video disk (DVD) player, or an information handling system. In one embodiment, different sets of data received through medium 105 are to be provided to particular devices, such as devices 160, 170 and 180.

Data source 110 is capable of using different channels, such as channels 150 and 155, for transmitting the sets of data to the devices 160, 170 and 180. A channel, such as first channel 150, can be configured for providing data to a device, such as first device 160, which can have different transmission needs than devices 170 and 180. For example, in one embodiment, first device 160 receives a signal with a worst signal-to-noise ratio than devices 170 and 180, as first device 160 can be located farther from the data source 110 than devices 170 and 180. A signal-to-noise ratio associated with a data signal received by the first device 160 may be too low for the first device 160 to distinguish data on first channel 150 with an acceptable bit error rate (“BER”). To improve the signal-to-noise ratio of the data signal, the data source 110 can modify power within the first data channel 150 with or without affecting a power associated with the second channel 155 and data sent to the devices 170 and 180. More power can be assigned to channels associated with some devices that need more power and less to channels associated with devices that can reliably receive data using less power. Power can be adjusted for each channel or for each portion of a channel associated with a particular device, such as first device 160. Power can be adjusted to allow the duration of packets sent on first channel 150 to match the duration of packets sent on second channel 155, improving channel throughput.

In operation, a greater amount of data may be required by a particular channel, such as first channel 150, than assigned to another channel, such as second channel 155. For example, in one embodiment, second device 170 and third device 180 are associated with a particular communications standard, such as IEEE 802.11a. Data source 110 can configure second channel 155 to operate within IEEE 802.11a standard specifications to accommodate devices 170 and 180. Accordingly, the second channel 155 is limited to a maximum data rate of 6 megabits per second due to a particular standard and environment. Further, the first device 160 may require an amount of data to be sent in a period of time in excess of a time used to transmit data at a data rate requested by the second device 170 over channel 155. Therefore, the specifications imposed on the second device 170 or the third device 180 may inhibit the first channel 150 from meeting power or data rate requirements of the first device 160. This disclosure discusses several options so that data source 110 can configure communication over the first channel 150 to meet the needs of the first device 160 without breaking specifications with the second device 170 or the third device 180.

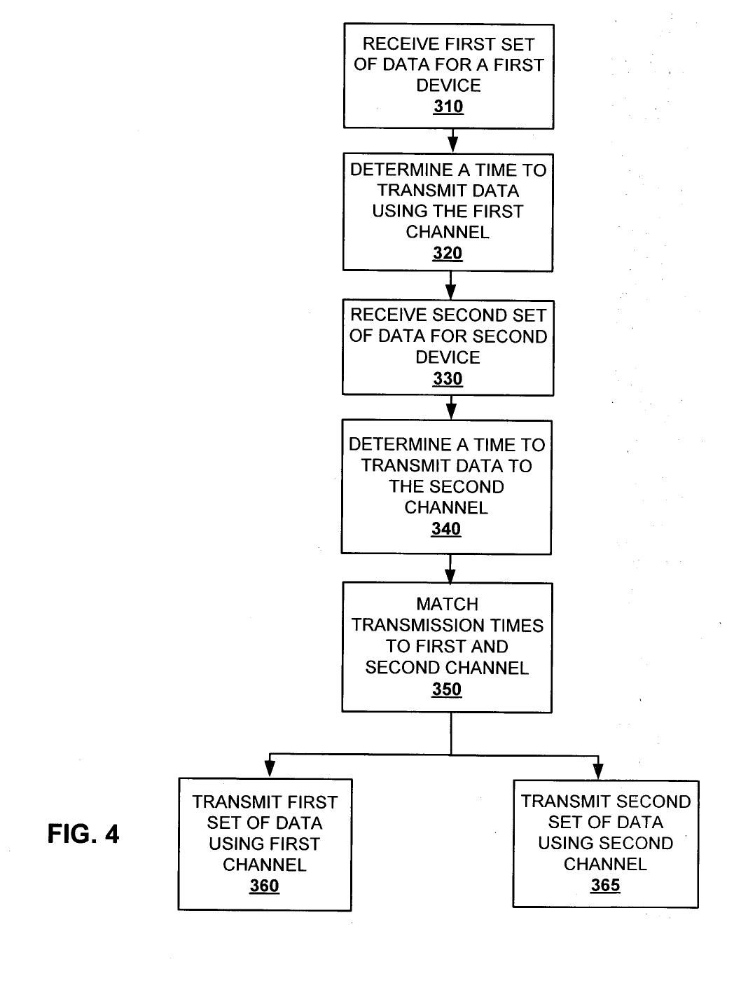

Data source 110 can alter a data rate associated with a channel by adjusting the number of bits per symbol assigned to the carriers within the channel. Data source 110 can also adjust a channel-coding rate used for data on a particular channel. It should be noted that a transmission time for a particular set of data, or data packet, associated with one channel, such as first channel 150, may be different from a time to transmit a data packet in another channel, such as second channel 155. A data packet is the set of data represented by a particular set of symbols being sent to a device. While packets may be sent simultaneously, an extended duration of a packet transmitted on a channel, such as second channel 155, in comparison to a duration of a packet transmitted on another channel, such as first channel 150, can inhibit a throughput of first channel 150. Communication on the first channel 150 can be restricted and first channel 150 may not be available due to the extended transmission on second channel 155. Accordingly, corrective measures may need to be enforced to improve channel throughput, as subsequently discussed in reference to FIGS. 4, 5 and 6. This can occur in the case of multiple channels transmitted from the same transmitter, as shown in FIG. 1. Alternative embodiments of the present invention are contemplated, and discussed more fully below, that use multiple transmitters to transmit multiple channels.

Data source 110 can include various components, such as data controller 115 and transceiver 140, for processing data to devices 160, 170 and 180. Data controller 115 can be used to read data received over medium 105, to identify a receiving device, such as devices 160, 170 or 180, or to define data packets. As previously discussed, medium 105 can include data from a variety of data providers. Medium 105 includes a particular medium or sets of media used to receive sets of data. Medium 105 can include electrical cabling, RF bands, and fiber optic cabling. Data received over medium 105 can be partitioned into different sets of data according to different frequency bands associated with different sets of data, different identifiers attached to different sets of data, different media used to receive the different sets of data. In one embodiment, data controller 115 identifies the different sets of data received through medium 105.

Data controller 115 can also identify different receiving devices, such as first device 160, second device 170 or third device 180, associated with the different sets of data. For example, in one embodiment, first device 160 is a high definition television (HDTV) receiver associated with HDTV data provided through medium 105. Second device 170 can include a standard definition television (SDTV) receiver associated with SDTV data received through medium 105. Third device 180 can include an information handling system connected to a network remote or node. In this case, identifiers are provided in data packets sent through first channel 150 or second channel 155. For example, a first identifier may be provided in a data packet sent to the first device 160. The first device 160 can then include the first identifier in data packets sent back to data source 110. Accordingly, all packets set and received from first device 160 may include the same identifier. Similarly, data packets sent and received from the second device 170 may include a second identifier; and, data packets sent and received from the third device 180 may include a third identifier, and so on for any additional devices. The identifiers may be provided through a header associated with transmitted data packets. In one embodiment, data sent to the first device 160, using the first channel 150, represents the same data as data sent to the second device 170, using the second channel 155. While the data sent to the first device 160 may represent the same data as the data sent to the second channel 155, the data sent to the first device 160 may be sent at a different data rate. Accordingly, the first channel 150 may be used to represent the same data as second channel 155 at a different bit rate, allowing devices to use either the first channel 150 or the second channel 155, dependent on a quality of signals received by the devices. For example, devices with a low SNR or high BER may select a data channel, first channel 150 or second channel 155, with a lower bits per symbol or a lower bit rate.

Data controller 115 can assign HDTV data received through medium 105 to first channel 150 for first device 160. Data controller 115 can assign a portion of HDTV data and streaming multimedia data to the second channel 155 for second device 170 and third device 180, respectively or for the first device 160. In this way, a device, such as first device 160, can receive a data transmission simultaneously along two different data channels. The portions of data received separately along the different channels can then be combined at the receiving device to form a complete transmission (e.g., the different data channels carry portions of a composite transmission). It should be noted that data controller 115, through medium 105, can also receive other forms of data. For example, medium 105 can include multimedia data from a digital video disk (“DVD”) player or satellite receiver. Data controller 115 may also be used to select particular programs identified in data received through medium 105. In one embodiment, devices 160, 170 and 180 return control data for use by data source 110, through transceiver 140, to indicate specific programs or channels to be selected from the data provided through medium 105.

Transceiver 140 provides data selected by data controller 115 to first device 160, second device 170 or third device 180. Transceiver 140 provides data for first device 160 on first data channel 150. Transceiver 140 provides data for second device 170 on a second data channel 155. In one embodiment, the data for each device 160 and 170 is mixed with a particular frequency to provide data at a unique channel frequency, such as for first data channel 150 or second data channel 155. Both the first data channel 150 and the second data channel 155 can be sent through a single transmitter using two separate frequency bands. Alternatively, different transmitters can be used for sending each data channel 150 and 155. By allowing data source 110 to configure particular channels to meet the needs of particular devices within a wireless network, an advantage is realized.

Transceiver 140 includes an initialization module 145 and a power module 147 for configuring properties associated with the channels 150 and 155. Initialization module 145 can be used to identify transmission properties, such as data channel signal-to-noise ratio, received BER, or signal power to determine properties of data received by devices 160, 170 or 180. For example, control data analyzed by initialization module 145 can indicate first device 160 being forced to drop received data packets. Initialization module 145 can provide a test data packet to first device 160 and analyze a response, such as an error check or acknowledgement, sent from first device 160 using transmitter 164, to determine a current reliability of first channel 150. Dependent on identified channel reliability, power module 147 can be used to alter a coding rate or allocate more or less bits per symbol to carriers within channels 150 and 155. The assignment of the coding rate or bits per symbol may be made in response to a signal-to-noise ratio associated with a channel characteristic, such as in first channel 150, or due to particular carriers that may have a lower signal-to-noise ratio than other carriers, within a same channel. To improve channel reliability, initialization module 145 can adjust a power used by transceiver 140 to transmit data across first data channel 150. In one embodiment, initialization module 145 sends control settings to a power module 147 to adjust the power. In another embodiment, power module 147 provides data signals to data controller 115. Accordingly, data controller 115 can send control settings to power module 147 to adjust a current transmission power.

Power module 147 can be used to adjust a signal, or transmission, power used to send data on first channel 150, second channel 155 and any other channel associated with data source 110. A data rate or code rate associated with data packets sent across the channel can also be adjusted by altering a transmission power used on a particular channel, such as first channel 150. Accordingly, power module 147 can adjust transmission power to match a duration of time used to transmit a first packet in the first channel 150 to a duration of time used to transmit a second packet in another of the plurality of channels that may be associated with data source 110, such as the second channel 155, thus improving channel throughput.

Adjusted transmission powers may reduce transmission problems associated with particular channels 150 and 155 or devices 160, 170 and 180. For example, first device 160 may have trouble receiving data because of a low signal-to-noise ratio. Initialization module 145 can assign a higher power to first data channel 150 to improve the signal-to-noise ratio on first data channel 150. Accordingly, initialization module 145 can provide control signals to power module 147 to increase the power allocated to the first data channel 150. Initialization module 145 may also assign less power to a data channel to improve power efficiency. For example, if first data channel 150 has an exceptionally high signal-to-noise ratio, initialization module 145 can reduce the power assigned to first data channel 150 through power module 147 (i.e., if the transmission power is greater than needed). The unused power can be assigned to another data channel or may be used to reduce a total power consumed by the data source 110. Alternatively, power module 147 can be used to adjust power to individual carriers assigned within the channels 150 and 155.

Once transmission powers have been altered, data source 110 can adjust data rates or coding rates associated with the data channels to match the durations of packets transmitted in parallel. As previously discussed, data controller 115 can also be used to assign the power adjustment using power module 147 without departing from the scope of the present invention. In one embodiment, power module 147 ensures that assigned transmission powers remain within regulatory specifications, such as FCC requirements.

Returning to FIG. 1, first device 160 includes a receiver 162 for receiving data via first data channel 150. Receiver 162 may include hardware or software for processing transmitted data into data usable by first device 160. Receiver 162 can de-modulate data transmitted over first data channel 150. Receiver 162 can also perform digital signal processing to retrieve data from first data channel 150. A handler 166 associated with first device 160 can be used to handle system settings, such as data rate control. Handler 166 can also be used to monitor a quality associated with data received through receiver 162. For example, handler 166 can provide a report regarding a number of dropped data bytes, an error check, or an acknowledgement, through transmitter 164. Transmitter 164 is used to provide data or acknowledgements back to transceiver 140, using any of the channels associated with data source 10, such as second data channel 155. The present invention provides the capability for transmitting data to data source 110 from a device, such as devices 160, 170 and 180, along any one channel or along multiple channels associated with data source 110. Further, the channel(s) used for transmitting from a device to data source 110 can be alternated as needed by a particular application.

Second device 170 includes a receiver 172 for receiving data from second data channel 155. Handler 176 can also monitor a quality of data received through receiver 172. Handler 176 can also control a transmission of an acknowledgement through transmitter 174 over, for example, second data channel 155. Similar to the second device 170, a third device 180 includes a receiver 182 for receiving data from second data channel 155. The third device also includes a handler 176 for processing acknowledgements and communications protocols. A transmitter 184 handles transmissions from third device 180 to the data source 10 over, for example, the second data channel 155.

It should be noted that data transmitted by first device 160, data transmitted by second device 170 and data transmitted by third device 180 are transmitted across at least one of the data channels associated with data source 110. However, in one embodiment, transceiver 140 may not receive all transmit data simultaneously. In such a case, devices 160, 170 and 180 employ a “listen before talk” transmission rule, in which transmitters 164, 174 and 184 must “listen” to, in the example of FIG. 1, second channel 155 before transmitting back data, such as according to the CSMA/CA protocol. While data source 110 is presented as providing data to three devices 160, 170 and 180, it should be appreciated that data source 110 can communicate with more or less devices without departing from the scope of the present invention.

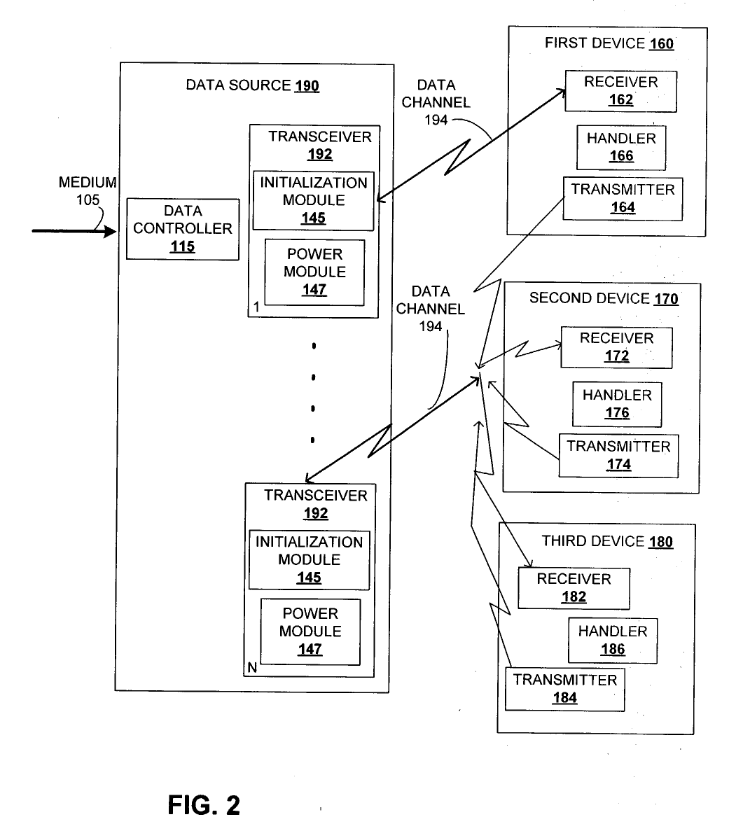

FIG. 2 is a simplified block diagram illustrating a multi-transmitter and multi-channel embodiment of a system and method for transmitting data to a plurality of devices in accordance with the present invention. In this embodiment, data source 190 includes multiple transceivers 192 representing a plurality of transceivers 1 through N, each comprising an initialization module 145 and a power module 147 as discussed with reference to FIG. 1. Each transceiver 192 has at least one corresponding data channel 194, analogous to data channels 150 and 155 of FIG. 1. Like-numbered components of FIGS. 1 and 2 perform the same functions. The operation of the embodiment of the present invention illustrated in FIG. 2 is otherwise the same as that of the embodiment of FIG. 1, with the added functionality of having multiple transceivers and multiple channels to transmit data to and to receive data from the plurality of devices represented by devices 160, 170 and 180.

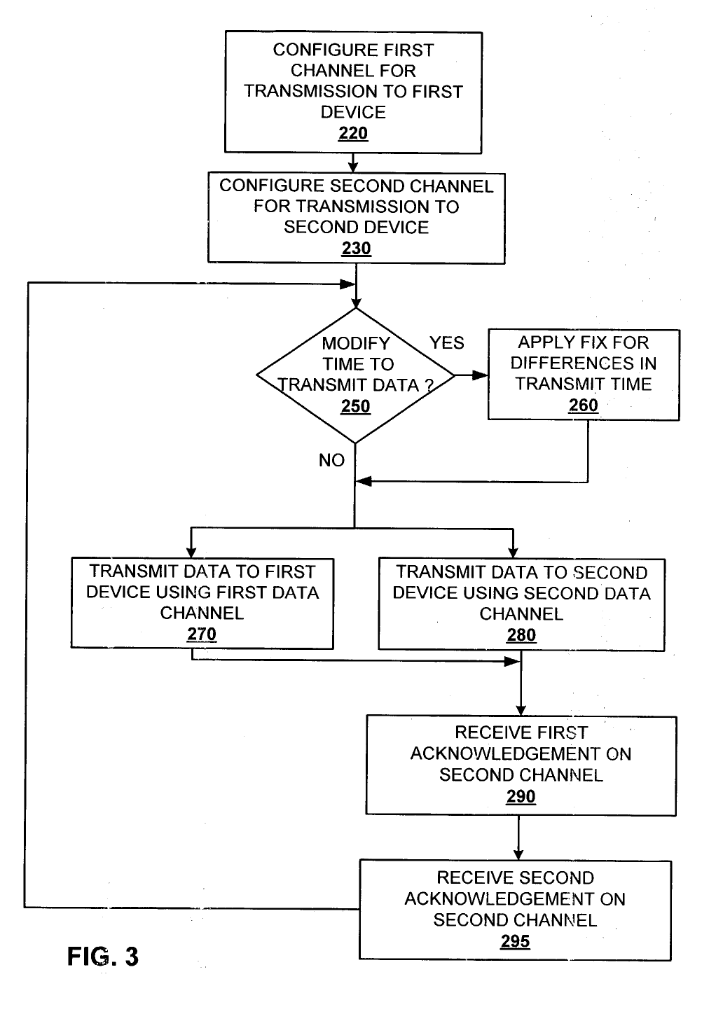

Referring now to FIG. 3, a flow diagram illustrating a method of transmitting data to a plurality of devices is shown, according to one embodiment of the present invention. It is important to note that the following discussion involves two devices and two data channels. However, the teachings of the present invention are equally applicable, and it is contemplated they will be applied to, systems comprising a plurality of devices, a plurality of transceivers and a plurality of data channels. In one embodiment, a data source is configured to provide data to both a first device and a second device. Communication with the second device is performed according to a communication standard, such as IEEE 802.11a, while communications with the first device may or may not be compliant with the same standard. In a system including more than two devices, communications with different devices may be performed according to different communication standards. To improve communications with the first device, data can be transmitted to the first device on a first data channel separate from a second data channel used to transmit data to the second device (or multiple other devices). However, data returned by both the first device and the second device is sent back on the second data channel in this example. Alternatively, data returned by the first and second devices, as well as any additional devices, can be returned along multiple channels used to transmit data to the devices, or along only a single channel as in this example.

In the subsequently discussed steps, a data source determines a reliability of transmission on a particular channel according to channel properties and an amount of data being transferred on the channel. The reliability can be determined in consideration to a maximum information capacity associated with the channel. Transmissions over a single data channel can be limited by the amount of data or information capacity that can be reliably transmitted across the single data channel. The information capacity theorem describes a relationship between a maximum amount of data that may be transmitted per unit time or information capacity, “C” of a particular channel, a channel bandwidth, “B”, a system scalar based on a desired BER and a modulation scheme being used, “η”, and a signal-to-noise ratio, “SNR”. One representation of the information capacity theorem can express channel capacity in bits per second according to the following equation:

$$C = B {log}_{2} ( 1 + \frac{SNR}{η} ) bits per second .$$

While it may appear that increasing a bandwidth assigned to a particular data channel linearly increases the information capacity for the data channel, allowing the data channel to transmit more data, a closer inspection reveals this is not correct. The signal-to-noise ratio is itself expressed in terms of the bandwidth. The greater the assigned bandwidth, the greater an amount of noise exposed to the data channel. A more appropriate form of the information capacity theorem can be expressed to further show the effect of bandwidth, “B”, transmission power, “P”, and standard thermal noise, “N₀”. Accordingly, the information capacity theorem can also be expressed as follows:

$$C = B {log}_{2} ( 1 + \frac{P}{η {N}_{0} B} ) bits per second .$$

As shown in the revised expression, the noise and bandwidth begin to degrade the information capacity. The channel capacity represents a bit rate per channel that may be reliably received in consideration of the noise allowed in the channel and the transmission power. For a fixed transmission power, the rate at which the information capacity increases with bandwidth approaches an asymptotic limit. Thus, as the bandwidth increases past a certain point, further increases in bandwidth do not provide efficient increases in information capacity. More efficient use of power can realized by assigning power to separate data channels to meet a specific information capacity needed by particular devices.

The data source may determine the reliability of data sent to the first device at a current data rate by calculating the capacity of the first data channel, such as is described using the information capacity theorem. In one embodiment, the data source is capable of sending data to both the first device and the second device using the same data channel. However, the first device is unable to adequately receive data at the same settings used to transmit data to the second device. For example, the first device may require a larger amount of data than the second device. Accordingly, a data rate assigned to the first channel for the first device can be configured higher than the second channel for the second device by appropriately allocating the power to favor the first device. A number of bits per symbol may be increased to accommodate for the higher data rate.

As an alternative to calculating reliability, the data source can use empirical methods to determine the reliability of data sent to the first device. For example, the data source can send a set of test data packets to the first device to determine how reliably the first device receives the data. The first device can return acknowledgements or an error check to indicate whether the data was adequately received. The data source can also use the tested reliability to determine settings adjustments for subsequent communications with the first device. Furthermore, the first device can report channel conditions to the data source. The first device may determine channel conditions, such as a received signal-to-noise ratio or BER, and transmit the channel conditions to the first device. The above discussion is equally applicable to any device associated with the data source.

In step 220 of FIG. 2, the data source configures a first data channel for transmissions to the first device. However, before the first device can receive data on the first data channel, the data source may need to inform the first device of a frequency, or set of frequencies, associated with the first data channel. The data source can also configure the first data channel for communicating with the first device. For example, the data source can apply a particular transmission power or data rate for data sent across the first data channel. In step 230, the data source configures a second data channel for communicating with the second device. As discussed with reference to step 220, the data source may need to coordinate settings associated with the second data channel with the second device. In one embodiment, the second data channel is configured to operate within a communications standard, such as IEEE 802.11. The second data channel is also configured to receive responses from the first and second device. In one embodiment, the second data channel is configured as a “listen before talk” data channel in which devices check to make sure the channel is not currently being used before transmitting data. This above functions can be performed for any data channel and device associated with the data source, such as data source 190 of FIG. 2.

In step 250, it is determined whether to modify packet durations. A time to transmit a set of data to the first device is compared to a time to transmit a set of data to the second device (or any device from a plurality of devices in an embodiment of this invention including a plurality of devices). The differences in time are compared to see if they are significantly different. The difference in transmit times may be compared to a timeout period set for an acknowledgement, as can be identified through a specification or standard associated with the first device. If the transmission times differ, problems may arise due to a limited response time used for acknowledgements, as discussed further in reference to FIG. 4.

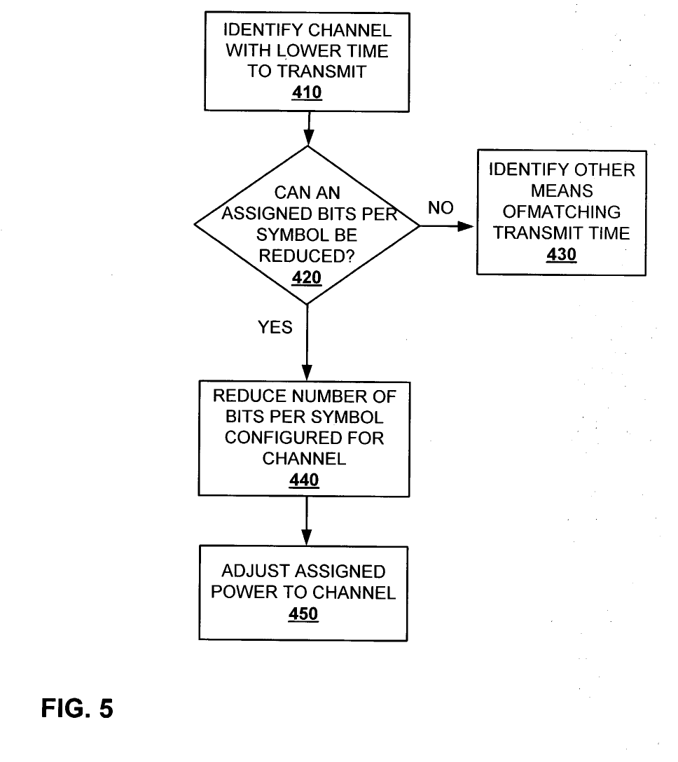

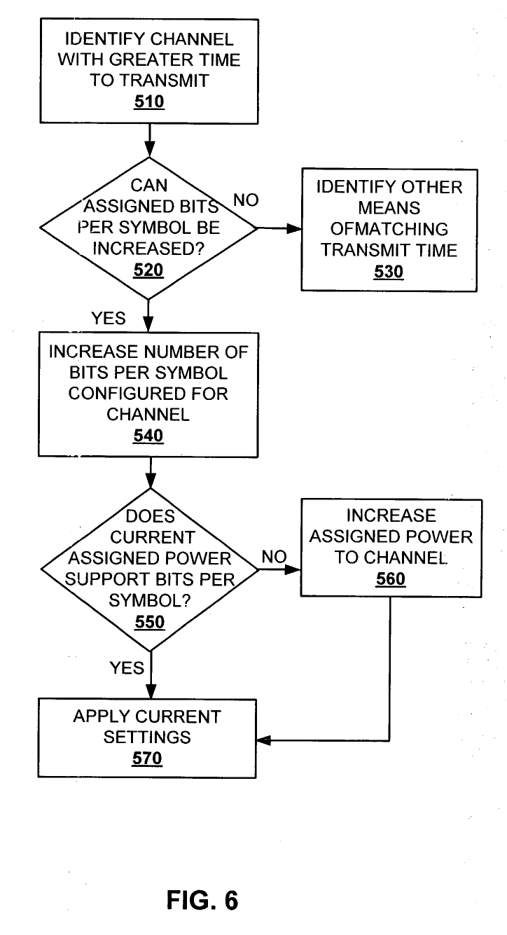

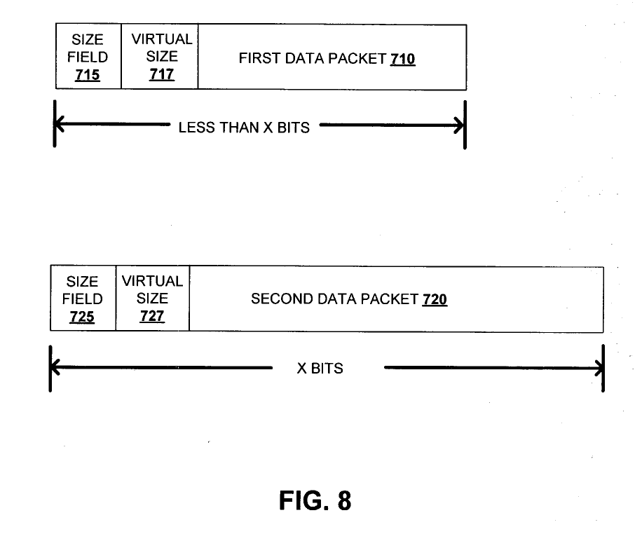

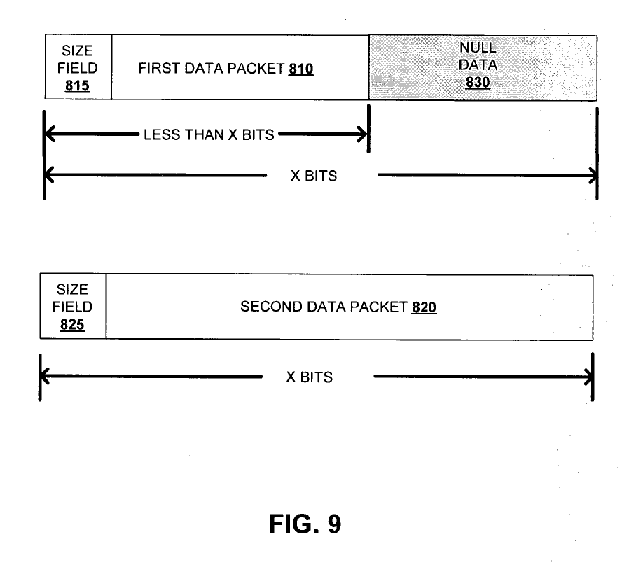

In step 260, if the differences in transmission time are significant, a fix may be necessary to allow transmitted packets to have similar durations. In one embodiment, a field is provided with the data sent to the device receiving less data to indicate a delay time. The device with a smaller transmission time may then wait for an amount of time allocated by the delay time. Additionally, a field can be provided to indicate a larger amount of data is being transferred. The receiving device can be forced to wait before trying to provide an acknowledgement, as described subsequently in reference to FIG. 8. Alternatively, the data associated with the smaller transmission time can be padded with null data to allow the transmission time to be congruent with the transmission time of the other set(s) of data, as discussed subsequently in reference to FIG. 9. Alternatively, the data source can alter the data rates used to transmit the sets of data, as discussed subsequently in reference to FIGS. 5 and 6. The data source can also delay a transmission of a data packet associated with a lower transmission time to allow the data packet to be fully transferred at substantially the same time as a data packet with a greater transmission time.

Alternatively, it may be desired to have a fix performed using the MAC layer. Accordingly, the MAC layer may be configured to adjust a number of bytes assigned per data packet. If the MAC layer detects a time to transmit a data packet in the first data channel is substantially less than a time to transmit a data packet in the second data channel, such as due to differences in the sizes of the data packets, numbers of bits per symbol or data rates assigned to the first data channel and the second data channel, the MAC layer may add more bytes to the data packet in the first data channel. Other methods of allowing the receiving devices to coordinate transmissions of acknowledgements can be performed without departing from the scope of the present invention. It should be noted that the data source can also adjust the time window in which it expects an acknowledgement for a particular set of data, allowing the data to respond late.

In step 270, the data source transmits data to the first device using the first data channel. In step 280, the data source transmits data to the second device using the second data channel. It should be noted that the data to the second device sent in step 280 can be transmitted concurrently with at least a portion of the data sent to the first device in step 270. In step 290, the data source receives a first acknowledgement on the second data channel. The first acknowledgment is related to a first receiving device that was able to send its acknowledgement of data received in either step 270 or step 280. It should be noted that the first acknowledgement may be from either the first device or the second device, and which device sends the acknowledgement is not pertinent to scope of the present invention. In step 295, a second acknowledgement is received on the second channel. The second acknowledgement may be related to another device, other than the originating device of the acknowledgement received in step 290. In one embodiment, the data source determines the next sets of data to be sent to the first device and the second device and the sizes of the data sets are compared, as in step 250.

FIG. 4 is a flow diagram illustrating a method of identifying transmission time discrepancies according to one embodiment of the present invention. As different data channels, such as a first data channel and a second data channel, can be configured to transmit data at different data rates or coding rates as well as data packets of different size, the amount of time used to transmit sets of data in each channel may differ. In one embodiment, to improve channel throughput, a fix can be applied to the data sent to the various devices, such as a first and a second device shown in FIG. 1, matching transmission times.

FIG. 3 illustrates an embodiment of this method for a two-device system. In step 310, the data source receives a first set of data intended for a first device. In step 320, the data source determines a time to transmit the first set of data using the first channel. The data source can identify the time to transmit based on several parameters configured for the first channel. For example, an assigned data rate or number of bits per symbol used by the first channel and the size of the first set of data can determine the transmission time associated with the first set of data. In step 330, the data source receives a second set of data. The second set of data is intended for a second device. In step 340, the data source determines an estimated transmission time associated with the second set of data using parameters associated with the second channel and the size of the second set of data.

In step 350, the data source matches the transmission times between the two sets of data using their respective channels, the first channel and the second channel. The transmission time may be matched by altering a transmission power, a data rate, or a coding rate associated with the first or second channel, as discussed subsequently in reference to FIGS. 5 and 6. The transmission times may be adjusted by adding null data to the set of data with a lower transmission time, as discussed subsequently in reference to FIG. 9, or by providing a virtual data size, as discussed subsequently in reference to FIG. 8. Alternatively, a MAC layer may be configured to add more bytes to the set of data with the lower transmission time. In step 360, the data source is free to transmit the first set of data to the first device using the first channel. In step 365, the data source transmits the second set of data to the second device using the second channel.

FIG. 5 is a flow diagram illustrating a method of handling a discrepancy in transmission time by increasing a time to transmit a set of data with a lower transmission time according to one embodiment of the present invention. As previously discussed, the time to transmit a first set of data may be different from the time to transmit a second set of data. A device may need to wait until a channel transmitting the set of data with a longer transmission time is done before using another channel. As a result, adjustments may need to be made to allow the sets of data to be transferred with congruent transmission times, improving channel throughput.

In step 410, the channel with a lower transmission time for a particular set of data is identified. In step 420, it is determined if the number of bits per symbol assigned to carriers of the identified channel can be reduced. The numbers of bits per symbol assigned to carriers of a data channel indicate a number of bits transferred for every symbol sent. If the bits per symbol are reduced, the data rate associated with the channel decreases. Accordingly, by reducing a number of bits per symbol associated with a channel, the transmission time can be increased to match a transmission time in another channel. However, it may need to be determined if the number of assigned bits per symbol is already too low for particular carriers of the data channel. For example, the currently assigned bits per symbol can represent a lower threshold of a standard associated with a receiving device. The receiving device may also require data to be received at the current rate and reducing the number of bits per symbol can force the receiving device to operate with reduced performance.

In step 430, if it is determined that the assigned bits per symbol may not be reduced, alternative forms of adjusting the transmission time may be attempted, as discussed subsequently in reference to FIG. 6. In step 440, if the bits per symbol may be reduced, the bits per symbol assigned to carriers of the channel are reduced. The reduced bits per symbol can be assigned to particular channels or only to particular carriers within the channels, as the bits per symbol may be limited to standard specifications on some carriers. Alternatively, a coding rate assigned to particular data channels can also be reduced to effect a change in packet duration. In step 450, a power assigned to the channel can be adjusted. As a data rate associated with the channel has been reduced, it may be desirable to lower the power assigned to the channel or to a particular carrier within the channel. The de-allocated power can be reallocated to other channels or conserved to reduce an overall power consumed by the data source 110 (FIG. 1).

FIG. 6 is a flow diagram illustrating a method of increasing a data rate associated with a channel to reduce discrepancies in transmission power according to one embodiment of the present invention. As previously discussed, differences in a transmission time to transmit a set of data in a first channel and another set of data in a second channel can cause a free channel to be made unavailable. Accordingly, properties associated with the channel sending the data with the greater transmission time can be altered to allow the different transmission times to be more congruent.

In step 510, the method identifies the channel with the data associated with the greater transmission time. The greater transmission time can be determined using the size of the set of data to be transmitted and a data rate associated with the data channel. In step 520, it is determined if the bits per symbol assigned to carriers of the identified channel can be increased. The data channel can be limited to specifications of a communications standard, such as IEEE 802.11. Accordingly, increasing the assigned bits per symbol associated with the channel may increase a data rate associated with the channel above a specified threshold. A receiving device may also be unable to handle data sent at a higher data rate. Furthermore, a power needed to reliably transmit data at the higher data rate may be unavailable. In step 530, if the bits per symbol cannot be adjusted, other means of adjusting the transmission time are employed, as discussed subsequently in reference to FIGS. 8 and 9.

In step 540, the numbers of bits per symbol configured for the identified channel are increased. The number of bits per symbol can be increased for the identified channel or only particular carriers associated with the identified channel. A data rate associated with the channel can be increased by increasing the number of bits per symbol. Accordingly, the time to transmit the set of data is reduced to be more congruent with the transmission time of a set of data in another data channel. Alternatively, a coding rate associated with the channel having the greater transmission time may be increased.

In step 550, it is determined if the transmission power associated with the identified channel is adequate. Higher rate signals are more susceptible to channel noise. As the data rate associated with the data channel has been increased, a higher transmission power may be needed. In step 560, the power assigned to the channel is increased to allow the set of data to be reliably sent at the higher data rate. In step 570, the settings to the channel are applied and the channel is free to send the set of data.

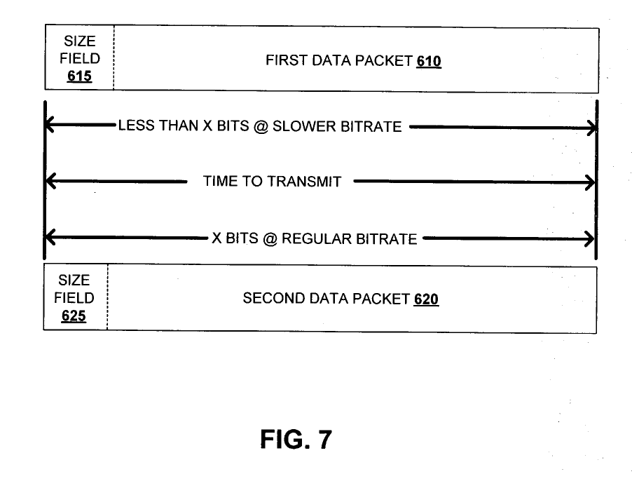

FIG. 7 is a block diagram illustrating a data rate adjustment to handle transmission time discrepancies between concurrently sent data packets according to one embodiment of the present invention. A data source, such as data source 190 of FIG. 2, sends a first set of data, first data packet 610 to a first device using a first data channel. The data source sends a second set of data, second data packet 620, concurrently with the first data packet 610, to a second device using a second data channel. The second data packet 620 is of a size X bits long, as indicated by a packet size field 625 provided with the second data packet 620. In comparison, the first data packet 610 is of a size less than X bits long, as indicated by a packet size field 615 provided with the first data packet 610. In one embodiment both the first device and the second device provide acknowledgements within a predefined period of time after reception of respective data packets 610 and 620. As the number of bits associated with the first data packet 610 is less than the number of bits associated with the second data packet 620, precautions may need to be taken to ensure the first data packet 610 is sent within substantially the same amount of time as the second data packet 620.

In one embodiment, an amount of time used to transmit the bits of the first data packet 610 to the first device is extended to match an amount of time required to transfer the bits of the second data packet 620. This concept can be extended in accordance with this invention to multiple devices, thus matching an amount of time required to transfer the bits of various other data packets. In one embodiment, a number of bits associated with each symbol of data in the first data packet 610 transferred to the first device is decreased, in respect to the number of bits per symbol used to transfer the second data packet 620. By decreasing the number of bits being transferred per symbol, the amount of time to transfer a data symbol associated with the first data packet 610 is increased. Accordingly, the amount of time to transfer the first data packet 610 can be made congruent with the amount of time needed to transfer the second data packet 620.

By forcing the first data packet 610 to be received in an amount of time congruent with the second data packet 620, acknowledgements associated with the first data packet 610 and the second data packet 620 may be received in time, despite the size of the first data packet 610 being less than the size of the second data packet 620. An extended use of a data channel for one receiving device can inhibit access to the data channel for another device to provide an acknowledgment, forcing the transmitting device to resend data. Accordingly, a throughput associated with the first channel can be improved if the data packets 610 and 620 are substantially congruent.

In one embodiment, it is desired to align symbol boundaries sent as part of the first data packet 610 with symbol boundaries sent as part of the second data packet 620 (or any other one or more of a plurality of data packets). Interference can be generated due to a transmission of a new symbol within a data channel. By transmitting the first data packet 610 symbol-aligned with the second data packet 620, interference between adjacent channels, such as the first data channel and the second data channel, can be reduced. Accordingly, the number of bits per symbol, or the data rate, used to transfer the first data packet 610 can be adjusted to allow the symbol boundaries in the first data packet 610 to align with symbol boundaries in the second data packet 620. The adjustment can be made to allow the data packets 610 and 620 to be symbol-aligned at the data source or at the receiving devices (e.g., the first device and the second device).

Furthermore, the number of bits per symbol assigned to the first data packet 610 or the second data packet 620 can be altered to allow the time used to transfer the data packets 610 and 620 to be slightly different, ensuring acknowledgements associated with the data packets 610 and 620 are not attempted at the same time. Accordingly, by allowing the time used to transfer the data packets 610 and 620 to be slightly different, the response time for acknowledgements can be adjusted without requiring a delay to be provided to the receiving devices. A coding rate associated with the data channels may also be modified to change the times used to transmit data packets 610 and 620. Alternatively, a number of carriers associated with the first channel can be reduced, as discussed in patent application XX.XXXXXX, entitled “SYSTEM FOR ALLOCATING DATA IN A COMMUNICATIONS SYSTEM AND METHOD THEREOF” and filed on Oct. 31, 2001, herein incorporated by reference.

In one embodiment, the data source reduces an amount of power used to transmit the first set of data 610 to follow a reduction in the number of bits to transmit per transmitted symbol. As previously discussed, the information capacity theorem can be used to show that an increase in power can support a higher channel capacity. The reverse is also true; a lower channel capacity does not need as high an amount of transmission power. Therefore, to make more efficient use of an available power, the data source or a transceiver associated with the data source can use a lower power if the number of bits transmitted per symbol or unit time in a particular data channel is decreased. In one embodiment, the number of bits transmitted per symbol and the power allocated to a particular data channel are linked. For example, allocating less power to the first data channel can force a transceiver system to allocate fewer bits per symbol being transmitted in the first data channel. Alternatively, a number of bins, or sub-bands, used in a particular data channel, such as the first data channel, can be decreased to transmit less data bits per unit time.

Referring now to FIG. 8, a block diagram illustrating data fields to correct for differences in transmission time is shown, according to one embodiment of the present invention. A data source sends a first data packet 710 to a first device using a first data channel. The data source sends a second data packet 720 to a second device using a second data channel. The first data packet 710 and the second data packet 720 are sent concurrently across their respective data channels. The second data packet 720 represents a set of data X bits long. In comparison, the first data packet 710 is smaller than the second data packet 720.

A virtual size field 717 is provided with the first data packet 710 to allow the first device to properly time an acknowledgement once the first device has received the first data packet 710. The first data channel can be made available after the acknowledgment associated with the first data packet 710, using the virtual size field 717. For purposes of discussion, data rates associated with the first and second data channels are assumed to be similar. Accordingly, the first data packet 710, being of a size less than X bits long takes longer to transmit than the second data packet 720. It should be appreciated that if the data rate of the first data packet is lower than the data rate of the second data packet 720, the time to transmit the first data packet can actually be greater than the time to transmit the second data packet.

In one embodiment, the data source supports only one set of data being transmitted over the second data channel at one time. For example, while the second data packet 720 is being sent across the second data channel, the data source cannot receive any other data on the second data channel, including the acknowledgements from the first and second devices. The first and second devices generally only have a particular time window in which to respond to received data by acknowledgement. After that time has passed, the data source ascertains that the data packet was not received. However, the first device can receive first data packet 710 before the second data packet 720 has been fully sent across the second data channel. In one embodiment, the data source, the first device and the second device communicate across the second data channel using a “listen before talk” protocol. Accordingly, the first and second device check to make sure that no data is being passed on the second data channel before submitting an acknowledgement on the second data channel. The time for the first device to acknowledge the first data packet 710 may pass before the second data packet is fully passed.

In one embodiment, packet size fields 715 and 725 are provided with data packets 710 and 720, respectively. Packet size fields 715 and 725 indicate a size of respective data packets 710 and 720 in terms of bits, allowing each device to know the total size of a data packet being received. In addition to the packet size field 715, first data packet 710 includes a virtual packet size 717. In one embodiment, virtual packet size 717 provides a packet size similar to the packet size of the second data packet 720, as indicated by packet size field 725. The virtual packet size 717 provides a packet size that the first device can use for timing an acknowledgement response. For example, the virtual packet size 717 can include the size of the second data packet 720, X bits. Accordingly, the first device can wait until a time to receive X bits passes before attempting to submit an acknowledgement, allowing the first data channel to be made available for further data transfer.

Alternatively to making the size of first data packet 710 appear congruent to the size of second data packet 720, the virtual size 717 can provide a size slightly different than second data packet 720, ensuring devices receiving first data packet 710 and second data packet 720 do not attempt acknowledgements at the same time. The virtual packet size 717 can also indicate the time for the first device to wait before submitting the acknowledgement. Alternatively to attaching fields 715 and 725 with respective data packets 710 and 720, the data source provides a ready-to-send (“RTS”) signal indicating the size fields 715 and 725 to the first and the second receiving devices, respectively. Accordingly, the RTS signal can be adapted to further include virtual size 717 in relation to first data packet 710.

As another alternative, an acknowledgement associated with the longer data packet (e.g., second data packet 720 ) can be delayed until after an acknowledgement of first data packet 710. As previously discussed, virtual size 717 can be used to delay an attempt made by a receiving device to acknowledge a receipt of first data packet 710 until after a transmission of the second data packet 720. A virtual size 727, associated with the second data packet 727, may delay an acknowledgement associated with the second data packet 727 until after the acknowledgement associated with the first data packet 710 has been sent. Accordingly, the acknowledgement associated with the shorter data packet (e.g., first data packet 710 ) is sent before the acknowledgement associated with the longer data packet (e.g., second data packet 720 ). It should be noted that other methods discussed herein may be used to allow the transmitted packets to be only slightly different in size, such as by one or more symbols, allowing the acknowledgements to be delayed due to the slight incongruence in packet lengths instead of due to forcing the receiver to delay its acknowledgement, as previously discussed.

FIG. 9 is a block diagram illustrating a data packet padded with null data according to one embodiment of the present invention. A data source sends a first data packet 810 using a first data channel. The data source sends a second data packet 820, concurrently with the first data packet 810, to a second device using a second data channel. The second data packet 820 is X bits long, as indicated in a packet size field 825 provided with the second data packet 820. Usable data in the first data packet 810 is less than X bits long, as indicated in a packet size field 815 provided with the first data packet 810. As previously discussed, the first and the second devices provide an acknowledgement after the reception of respective data packets, first data packet 810 and second data packet 820, using the second data channel. For discussion purposes, data rates associated with the first and second channels are assumed to be similar. As previously discussed, while the first data packet 810 includes less bits than the second data packet 820, if the first data packet is sent at a lower data rate, the transmission time associated with the first data packet 810 may be greater than the transmission time associated with the second data packet 820.

In one embodiment, null data 830 is added to data packet 810. The null data 830 provides padding to the first data packet 810 to make up a difference in transmission time between the first data packet 810 and the second data packet 820 (or any other data packet associated with a data source, such as data source 190 of FIG. 2). Therefore, the first device is forced to wait until it has received X bits, due to a reception of the usable data of first data packet 810 with the null data 830. The null data 830 provides ample time for the second data packet 820 to be passed on the second data channel before the first device attempts to send an acknowledgement. In one embodiment, the packet size field 815 only indicates the size of first data packet 810, without the null data 830. Alternatively, the packet size field 815 can indicate a size of X bits, providing the number of bits including the first data packet 810 and the null data 830. Null data 830 is used to make a size of the first data packet 810 as received by the first device to appear to be congruent with the size of a second data packet 820.

In one embodiment, null data 830 includes data values that are not to be processed by the first device. While null data 630 is described as allowing the first data packet 810 to match a data size associated with the second data packet 820, if the data rates associated with the first and second channels are significantly different, the size of first data packet can be adjusted by null data 630 to a size different than the size of the second data packet 820 to match the transmission times between the first and second data packets 810 and 820, improving throughput and maximizing availability associated with the first and second data channels. By adjusting the amount of time to transmit the first set of data 810 and the second set of data 820, acknowledgements associated with receipt of the first and second data packets 810 and 820 may be controlled.

While the addition of null data 830 is discussed, it should be noted that other data may also be added to the first data packet 810. Furthermore, the MAC layer may be used to apply the extra data to the first data packet 810. Accordingly, the first data packet 810 and the second data packet 820 may be compared to determine whether the times to transmit the data packets 810 and 820 are congruent. If the times to transmit the data packets 810 and 820 are not congruent, due to either different data rates, bit rates, or data packet sizes, the MAC layer may add more bytes to the first data packet 810 to ensure the transmit times are congruent. Furthermore, it may be desirable to adjust the transmission times associated with the first and second data packets 810 and 820 to be slightly different, by one or more symbols, ensuring acknowledgements associated with the first and second data packets 810 and 820 timely returned. Accordingly, the return of acknowledgements can be adjusted without requiring a receiving system to initiate a delay before administering an acknowledgement. It should be noted that while an addition of null data 830 is shown attached to the end of first data packet 810, null data 830 may be added at the start of first data packet 810 or provided within the first data packet 810, without departing from the scope of the present invention.

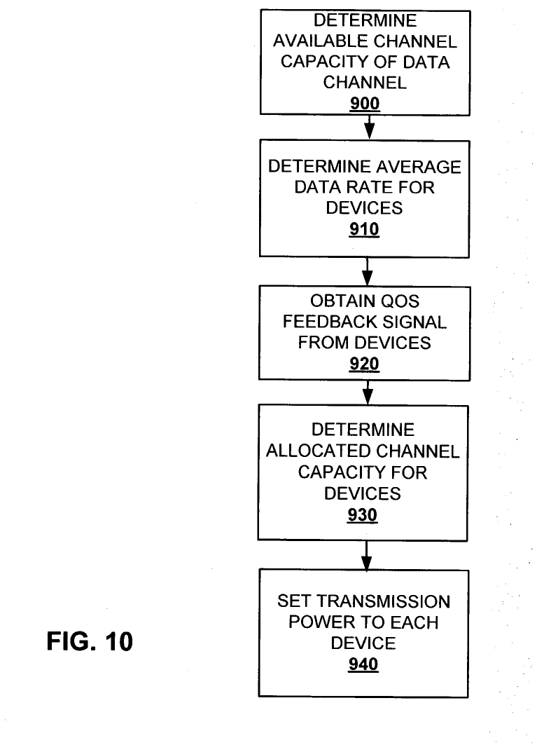

FIG. 10 is a flowchart illustrating an embodiment of a method for adjusting transmission power on a data channel in accordance with the teachings of the present invention. At step 900, the method determines the available channel capacity of the data channel. The data channel can be a data channel as described with reference to previous figures in this disclosure. The data channel can further be used to transmit data to one or more devices. At step 910, the method determines an average data rate for each of the one or more devices. Each of the one or more devices provides a quality of service (“QOS”) feedback signal to, for example, a data source 190 (i.e., data source 190 can obtain a QOS feedback signal from each device) at step 920. At step 930, the method continues by determining an allocated channel capacity for each of the one or more devices based on one or more of: the device average rate, the device QOS feedback signal, and the available channel capacity. At step 940, the method sets the transmission power to each device based on the allocated channel capacity for that device. The transmission power can be adjusted for all devices or to only some or none of the devices. For example, some devices may not need to have their channel transmission power adjusted, or a system implementing an embodiment of the present invention may not wish to change the transmission power on a channel to a given device. These and other such permutations are contemplated to be within the scope of this invention.

Embodiments of the method of this invention described with reference to FIG. 10 can further include the step of configuring the data channel to further receive data associated with the one or more devices, such as an acknowledgement of receiving the transmitted data. Further, the step of determining the allocated channel capacity can also be based on an amount of data to be transmitted to each of the one or more devices and/or on a received signal quality, wherein the received signal quality can be provided by the one or more devices as part of the QOS feedback signal. The signal quality can be based on a signal-to-noise ratio and/or on a bit error rate. Additional embodiments of this method can include the step of transmitting data to the one or more devices at a default data rate prior to determining the allocated channel capacity. The one or more devices can be associated with a set of specifications associated with a communication standard, such as the IEEE 802.11 standard.

The systems described herein may be part of an information handling system. The term “information handling system” refers to any system that is capable of processing information or transferring information from one source to another. An information handling system can be a single device, such as a computer, a personal digital assistant (PDA), a hand held computing device, a cable set-top box, an Internet capable device, a cellular phone, and the like. Alternatively, an information handling system can refer to a collection of such devices. It should be appreciated that the system described herein has the advantage of providing data to a plurality of devices. The embodiments of the present invention can further be implemented within a multimedia system such as disclosed in U.S. patent application, Attorney Docket No. VIXS-003, entitled “METHOD AND APPARATUS FOR A MULTIMEDIA SYSTEM” filed on ______ to inventors ______, which is hereby fully incorporated by reference.

In the preceding detailed description of the embodiments, reference has been made to the accompanying drawings, which form a part thereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. Furthermore, many other varied embodiments that incorporate the teachings of the present invention may be easily constructed by those skilled in the art. For example, additional embodiments of the invention disclosed herein can comprise a system for performing some or all of the functions described with reference to the accompanying Figures. Accordingly, the present invention is not intended to be limited to the specification set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present invention is defined by the appended claims.

What is claimed is:

1. A method comprising:
transmitting a first plurality of sets of data on a plurality of data channels to a plurality of devices, wherein each of the first plurality of sets of data has a corresponding channel from the plurality of data channels and is transmitted to a corresponding device of the plurality of devices; and
receiving a second plurality of sets of data on at least one of the plurality of data channels, wherein the second plurality of sets of data is sent by the plurality of devices, and wherein each of the second plurality of sets of data has a corresponding device of the plurality of devices.

2. The method as in claim 1, wherein each of the second plurality of sets of data includes an acknowledgement from its corresponding device of the reception of at least one of the first plurality of sets of data.

3. The method as in claim 1, wherein different channels of the plurality of data channels include separate bands of frequencies.

4. The method as in claim 1, wherein the plurality of devices are associated with a communication standard.

5. The method as in claim 4, wherein the communication standard includes an IEEE 802.11 communication standard.

6. The method as in claim 1, wherein at least one of the first plurality of sets of data is transmitted at a higher data rate than others of the first plurality of sets of data.

7. The method as in claim 1, wherein different sets of data of the first plurality of sets of data include differing amounts of data.

8. The method as in claim 1, wherein at least one of the plurality of clients simultaneously receives multiple sets of data of the first plurality of sets of data along at least two of the plurality of data channels.

9. The method as in claim 8, wherein the multiple sets of data of the first plurality of sets of data together comprise a composite data set and wherein the multiple sets of data of the first plurality of sets of data are combined at the at least one of the plurality of devices to form the composite data set.

10. The method as in claim 1, wherein the plurality of data channels comprise alternate adjacent data channels.

11. The method as in claim 1, wherein the plurality of data channels comprise adjacent data channels.

12. The method as in claim 1, wherein the plurality of data channels have a corresponding plurality of transmitters.

13. The method as in claim 1, wherein at least one of the plurality of data channels provides data sets to multiple devices of the plurality of devices.

14. The method as in claim 1, wherein multiple sets of data of the first plurality of sets of data are transmitted on the same corresponding channel from the plurality of data channels.

15. The method as in claim 1, wherein at least one of the plurality of devices does not send a corresponding data set as part of the second plurality of data sets.

16. The method as in claim 1, wherein the at least one channel carrying the second plurality of sets of data can alternate among the plurality of data channels.

17. The method as in claim 1, further including the step of controlling a time to transmit a first set of data of the first plurality of sets of data to a first device of the plurality of devices.

18. The method as in claim 17, wherein the step of controlling the time to transmit the first set of data includes padding the first set of data with null data to allow a packet length associated with the first set of data to be congruent with a packet length associated with at least one other set of data of the first plurality of sets of data.

19. The method s in claim 17, wherein the step of controlling the time to transmit the first set of data includes providing a field value with the first set of data, wherein the field value indicates a time period before the first device may send an acknowledgment.

20. The method as in claim 17, wherein the step of controlling the time to transmit the first set of data includes adjusting a number of bits sent per unit time associated with the first set of data to allow a packet length associated with the first set of data to be congruent with a packet length associated with at least one other set of data of the first plurality of sets of data.

21. The method as in claim 17, wherein the step of controlling the time to transmit the first set of data includes adjusting a number of bits sent per unit time associated with the first set of data to allow a packet length associated with the first set of data to be non-congruent with a packet length associated with at least one other set of data of the first plurality of sets of data.

22. The method as in claim 17, wherein the step of controlling the time to transmit the first set of data includes adjusting a number of bytes assigned to the first set of data by a medium access control layer to allow a packet length associated with the first set of data to match a packet length associated at least one other set of data of the first plurality of sets of data.

23. The method as in claim 17, wherein the step of controlling the time to transmit the first set of data is performed to control a transmission of an acknowledgement associated with the first set of data.

24. The method as in claim 17, wherein the step of controlling the time to transmit the first set of data includes aligning symbol boundaries in the first set of data to symbol boundaries in at least one other set of data of the first plurality of sets of data to reduce interference between the data channel corresponding to the first set of data and the data channel corresponding to the at least one other set of data of the first plurality of sets of data.

25. A method for adjusting a transmission power on a data channel transmitting to one or more devices, comprising:
determining an available channel capacity of the data channel;
determining an average data rate for each of the one or more devices;
obtaining a quality of service (“QOS”) feedback signal from each of the one or more devices, determining an allocated channel capacity for each of the one or more devices based on one or more of the device average rate, the device QOS feedback signal, and the available channel capacity; and
setting the transmission power to the one or more devices based on the allocated channel capacity.

26. The method as in claim 25, wherein the step of determining the allocated channel capacity is further based on an amount of data to be transmitted to each of the one or more devices.

27. The method as in claim 25, wherein the step of determining the allocated channel capacity is further based on a Deceived signal quality, wherein the received signal quality is provided by the one or more devices as part of the QOS feedback signal.

28. The method as in claim 27, wherein the signal quality is based on a signal-to-noise ratio.

29. The method as in claim 27, wherein the signal quality is based on a bit error rate.

30. The method as in claim 25, further comprising the step of transmitting data to the one or more devices at a default data rate prior to determining the allocated channel capacity.

31. The method as in claim 25, wherein the one or more devices are associated with a set of specifications associated with a communication standard.

32. The method as in claim 31, wherein the communications standard includes IEEE 802.11.

33. A system comprising:
a source device to communicate with a plurality of devices, the source device including:
a transmitter portion to transmit a first plurality of sets of data on a plurality of data channels to the plurality of devices, wherein each of the first plurality of sets of data has a corresponding channel from the plurality of data channels and is transmitted to a corresponding device of the plurality of devices; and
a receiver portion to receive a second plurality of sets of data on at least one of the plurality of data channels, wherein the second plurality of sets of data is sent by the plurality of devices, and wherein each of the second plurality of sets of data has a corresponding device of the plurality of devices.

34. The system as in claim 33, wherein the plurality of devices is associated with a set of specifications of a communication standard.

35. The system as in claim 34, wherein the communications standard includes IEEE 802.11.

36. The system as in claim 33, wherein the transmitting portion includes a plurality of transmitters to transmit corresponding channels of the plurality of data channels.

37. The system as in claim 33, wherein the transmitting portion is further used to identify a plurality of transmission powers to associate with corresponding devices of the plurality of devices.

38. The system as in claim 37, wherein a transmission power of the plurality of transmission powers is determined based on properties associated with its corresponding device.

39. The system as in claim 38, wherein the properties include a quality of service desired by the corresponding device.

40. The system as in claim 38, wherein properties include an amount of data to be transmitted to the corresponding device.

41. A method for adjusting a transmission power on a data channel transmitting to one or more devices, comprising:
determining an available channel capacity of the data channel;
determining an average data rate for each of the one or more devices;
obtaining a quality of service (“QOS”) feedback signal from each of the one or more devices;
determining an allocated channel capacity for each of the one or more devices based on one or more of the device average rate, the device QOS feedback signal, and the available channel capacity;
setting the transmission power to the one or more devices based on the allocated channel capacity; and
configuring the data channel to further receive data associated with the one or more devices.

42. The method as in claim 41, wherein the data associated with the one or more devices includes acknowledgements associated with data sent to the one or more devices.

43. The method as in claim 41, wherein the step of determining the allocated channel capacity is further dependent on a time required to transmit data to the one or more devices.

44. The method as in claim 41, wherein the step of determining the allocated channel capacity is based on an amount of data to be transmitted to the one or more devices.

45. The method as in claim 41, wherein the step of determining the allocated channel capacity is based on a signal quality.
